(19) United States
(12) Patent Application Publication
(10) Pub. No.: US 2017/0221028 A1
(43) Pub. Date: Aug. 3, 2017

(54) METHOD FOR ONLINE FUNDING THE CREATION OF CONTENT

(71) Applicant: JOHN SICOLI, Strathroy (CA)

(72) Inventor: JOHN SICOLI, Strathroy (CA)

(21) Appl. No.: 15/514,612

(22) PCT Filed: Sep. 29, 2015
(86) PCT No.: PCT/CA2015/000524

§ 371 Date: Mar. 27, 2017

Related U.S. Application Data
(60) Provisional application No. 62/057,534, filed on Sep. 30, 2014.

(51) Int. Cl. G06Q 20/12; G06Q 30/06

(52) U.S. Cl. CPC G06Q 20/12; G06Q 30/0635

(57) ABSTRACT

A method of raising funds for the creation of artistic works by obtaining financial contributions from interested individuals. An author uploads an artistic work to a website and offers visitors to the website creative control to the artistic work or parts thereof in exchange for payment.

### FIELD OF THE INVENTION

The present invention relates to methods of raising funds, in particular, to obtaining financial contributions from interested individuals for the creation of content, such as artistic works, in exchange for some degree of artistic control over the content.

### BACKGROUND

Many writers, musicians, and other authors and artists have difficulty in completing content due to a lack of financial resources to cover the costs associated therewith. For example, musical content requires the individual or group of musicians to record, market, and distribute copies of the recording before any financial return can be generated. These steps are associated with significant costs that present an insurmountable barrier to many authors and artists.

Methods and systems are known that provide artists a way of raising funds for the creation of content, such as U.S. Pat. No. 7,885,887 B2, “Methods and Apparatuses for Financing and Marketing a Creative Work”. However, known methods and systems involve the offering of entitlements such as copies of the creative work, upon completion thereof, or collectible items related to the artist. Such methods amount to a pre-sale of the creative work or collectible items. Often, the amount paid for such an entitlement is less than the amount that would otherwise be paid for the completed creative work. Both the creative work, once completed, and the collectible items could be sold independently of such a method or system and could otherwise generate revenue for the artist.

Accordingly, there is a need for a method and/or system that allows an author to raise the necessary funds to complete content that does not rely on the sale of discounted items that could otherwise be sold by the author to generate revenue.

### SUMMARY OF THE INVENTION

To meet the need identified above, the present invention provides methods for raising funds for the creation of content, such as artistic works, by which interested individuals can provide financial contributions to a project in exchange for some degree of artistic control over one or more parts of the content.

One aspect of the present invention is a computerized method for raising funds for the creation of artistic works, comprising the steps of receiving an artistic work from an author, displaying at least a portion of the artistic work on a website accessible to visitors, offering creative control to the artistic work or parts thereof to the visitors to the website in exchange for payment, and receiving payment from one or more of the visitors in exchange for conveyance of the creative control.

In another embodiment, the method further comprises the steps of displaying options to exercise the creative control to the one or more of the visitors, receiving an election from the one or more of the visitors to exercise the creative control, storing the election in a database, and transmitting the election to the author.

### BRIEF DESCRIPTION OF THE DRAWINGS

In order that the invention may be more clearly understood, preferred embodiments thereof will be described in detail, by way of example, with reference to the accompanying drawings, in which:

FIG. 1 is a flow chart, showing the steps for an author to create a project.

FIG. 2 is a flow chart, showing the steps for a visitor to create an account and log in to the website.

### DESCRIPTION OF THE PREFERRED EMBODIMENT

As used in the following description, the term “content” refers to one or more artistic works, such as, for example, musical recordings, performances, lectures, choreography, films, television programs, literature, newspaper or magazine articles, pamphlets, scripts, paintings, drawings, maps, charts, plans, photographs, engravings, sculptures, works of artistic craftsmanship, or architectural works. The term “content” may also refer to a compilation of artistic works.

As used in the following description, the term “creative control” refers to the determination or selection of parts of content. Every part of the content is subject to creative control, usually by the author, including, in the case of a film for example: plot elements, the script, the title of the film, cast members for one or more roles, the director, filming location, alternate scenes/endings, character names, costume or set elements, or any other part of the film.

As used in the following description, the term “project” refers to content, such as an artistic work, including an unfinished artistic work, and a fundraising effort therefor, which an author has started through a fundraising website, as further described below.

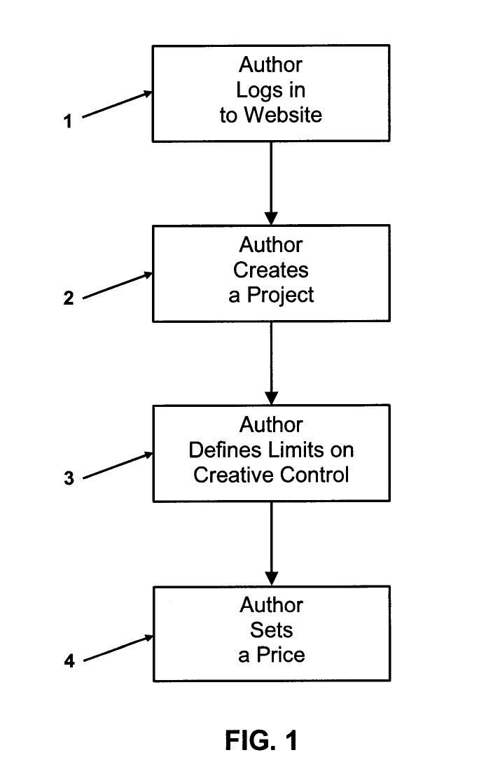

In one embodiment of the method according to the present invention, as shown in FIG. 1, an author logs on to a fundraising website 1, using a computer executing an internet browsing application. The author may also upload content at any stage of completion to a project server, over a network such as the internet, for posting on the fundraising website in a “projects” area. A hosting server, which may be the same as the project server, is part of, or coupled to, an internet service provider to provide access to the fundraising website over the Internet. The computer and server used for the purposes of the present invention are known to a person of skill in the art and generally include a processor, memory, and input/output capability coupled to a system bus, capable of storing data and instructions, which may be executed by the processor to perform the methods described herein.

Although the present invention is described in relation to internet-based network connections, other types of network connections may be used, for example, private networks. Further, although the present invention is described in relation to a computer, which may include various computing devices, such as desktop computers or laptop computers, other types of electronic devices may be used, such as tablets, smartphones, or other electronic device capable of storing, transmitting, and receiving information, data, and instructions, which may be executed by a processor.

The author creates a project 2 by outlining the type of content to which the project relates and what content will be open to creative control by visitors to the website. The content may also be a collection that includes more than one artistic work, such as, a musical recording album, which consists of a plurality of individual songs. The author specifies certain parts of the content, which will be open to creative control by visitors to the fundraising website. The author may also provide additional information concerning the content, such as a working title, alternate endings, or a description of the portions of the content which are incomplete. The additional information will be displayed along with the content in the “projects” area of the fundraising website. Access to the content by visitors to the fundraising website may be limited by the author, for example, in the case of a novel, access may be limited to a synopsis or one or more excerpts from the novel, and in the case of a musical recording, access may be limited to a brief clip of the entire recording.

The author then defines certain limits on the creative control 3 over the content, which will be available to visitors to the website. For example, the author may limit the available creative control by describing and defining only certain parts of the content which will be open to creative control by visitors. The author may define and describe more than one set of limits, or levels of creative control. The author finally sets a price 4, or donation amount, for each set or level. Alternatively, this may be done through a set of online tools that provide the author with various pre-determined options, one or more of which may be selected each with a corresponding price, which may be pre-determined or set by the author.

Visitors to the “projects” area of the fundraising website will receive an offer to purchase some degree of control over one or more pieces of the content (i.e. One or more works). Preferably, a visitor will receive an offer relating to a particular piece of content while viewing that content in the “projects” area of the fundraising website.

The offer may, therefore, include different levels of creative control, corresponding to different prices. The different levels of creative control may also relate to different parts of the content. For example, the author may define two levels of creative control in which a small payment entitles a visitor to select the title of the content from a list of potential titles, a larger payment entitles a visitor to additionally select the ending of the content from a list of potential endings. Creative control over any part of the content may be offered by the author, such as, in the case of a film for example, selection of: cast members for one or more roles, the director, filming location, alternate scenes/endings, character names, costume or set elements, or any other part of the film.

The scope of the creative control that is open to the visitor is determined as described above, but the type of creative control privileges may also vary. Preferably, the type of creative control that visitors will be offered over a particular piece of content will be voting privileges concerning a list of pre-determined options for one or more parts of the content. The author may elect to offer other types of control, such as complete and exclusive control over certain parts of the content. Exclusive control may, for example, involve exclusive selection by one individual of certain parts of the content from a list of pre-determined options. The author may also offer a first type of control over a first part of the content and a second type of control over a second part of the content. For example, in the case of a film, the author may choose to offer exclusive selection privileges over certain costume or set elements, while offering voting privileges concerning the selection of cast members and alternate endings.

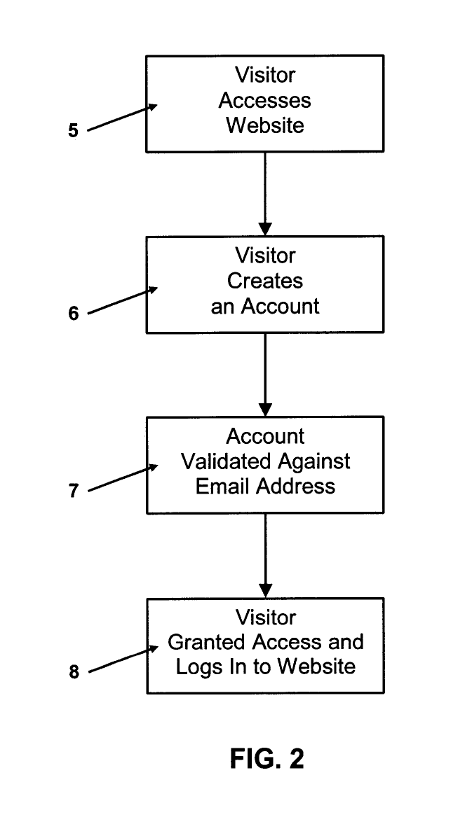

In order to exercise any purchased creative control privileges, a visitor will access the fundraising website 5, for example, as shown in FIG. 2, using a web browser on a personal computer with an internet connection. The visitor will then create an account 6 and choose a password. The account is validated against a current email address 7 and the visitor is granted access and logs in 8 with the account and password.

The visitor will then have access to any purchased creative control privileges and may elect to exercise one or more of these privileges. The user may be given access to any purchased creative control privileges directly in the “projects” area of the fundraising website, or through a separate “privileges” area, which displays all of the creative control privileges the visitor has purchased.

When a visitor exercises a purchased creative control privilege, such as a voting privilege, the election is transmitted to a creative control server to be recorded and processed. The creative control server may be the same server as the hosting and/or the project server, or a separate server. In the example of voting privileges, the vote cast by the visitor is transmitted to the creative control server where it is recorded in a database, corresponding to the part of the content to which the vote relates. The votes are counted and the results posted on the “projects” area of the fundraising website, either as a real-time running tally of the votes cast or as a final total once certain conditions are met to end the voting. These conditions, which are referred to herein as “closing conditions”, may be the expiry of a certain window of time or the accumulation of a pre-determined target amount of money. Once the closing conditions are met, creative control over that part of the content is closed and no further offers are made to visitors, in respect of that part of the content.

Visitors who have purchased creative control privileges, but have not exercised them before the closing conditions are met, may be given an opportunity to exercise their privileges before the corresponding part of the content is finalized. For example, visitors who have purchased voting privileges concerning the title of a film with closing conditions dependent on the accumulation of a target amount of money may be given ten days, after the target is reached, to cast their vote before the votes are counted and the title is chosen. Alternatively, visitors may be permitted to exercise all purchased creative control privileges for a given piece of content until a certain date, regardless of whether any other closing conditions have been met.

The methods of the present invention, described above, are carried out by one or more computers and servers, executing instructions from computer-readable media. The description of the methods above enables one of skill in the art to develop computer software in a variety of programming languages, containing instructions that can be executed on a variety of hardware platforms by a variety of operating systems to carry out the methods of the present invention.

What is claimed is:

1. A computerized method for raising funds for the creation of artistic works, comprising the steps of:
receiving an artistic work from an author;
displaying at least a portion of the artistic work on a website accessible to visitors;
offering creative control to the artistic work or parts thereof to the visitors to the website in exchange for payment; and
receiving payment from one or more of the visitors in exchange for conveyance of the creative control.

2. The computerized method of claim 1, further comprising the steps of:
displaying one or more options to exercise the creative control to the one or more of the visitors; and
receiving an election from the one or more of the visitors to exercise the creative control.

3. The computerized method of claim 2, further comprising storing the election in a database.

4. The computerized method of claim 3, further comprising transmitting the election to the author.

5. The computerized method of claim 4, wherein the artistic work is selected from the group consisting of musical recordings, performances, lectures, choreography, films, television programs, literature, newspaper or magazine articles, pamphlets, scripts, paintings, drawings, maps, charts, plans, photographs, engravings, sculptures, works of artistic craftsmanship, architectural works, or compilations.

6. The computerized method of claim 1, wherein the step of offering creative control to the artistic work or parts thereof comprises offering creative control to a plurality of sets of one or more parts of the artistic work.

7. The computerized method of claim 6, wherein the step of offering creative control to a plurality of sets of one or more parts of the artistic work further comprises selecting one or more types of creative control for each set of one or more parts of the artistic work.

8. The computerized method of claim 7, wherein the one or more types of creative control comprises voting privileges concerning the set or one or more parts of the artistic work.

9. The computerized method of claim 7, wherein the one or more types of creative control comprises exclusive selection privileges from a list of pre-determined options concerning the set of one or more parts of the artistic work.

10. The computerized method of claim 1, wherein offers of creative control are made to the visitors only until one or more closing conditions are met.

11. The computerized method of claim 10, wherein the one or more of the visitors who have purchased creative control privileges before the one or more closing conditions are met, but have not yet exercised the conveyed creative control, are given an opportunity to exercise the conveyed creative control.

12. The computerized method of claim 11, wherein the one or more closing conditions are selected from the group consisting of: the expiry of a window of time or the accumulation of an amount of money.
